(19) United States
(12) Patent Application Publication
(10) Pub. No.: US 2023/0337864 A1
(43) Pub. Date: Oct. 26, 2023

(54) Small Paper Dish for Cooking Utensils

(71) Applicant: Michael Anthony Terranova, West Haven, CT (US)

(72) Inventor: Michael Anthony Terranova, West Haven, CT (US)

(21) Appl. No.: 18/176,285

(22) Filed: Feb. 28, 2023

Related U.S. Application Data
(60) Provisional application No. 63/333,429, filed on Apr. 21, 2022.

(51) Int. Cl. A47J 47/16

(52) U.S. Cl. CPC A47J 47/16

(57) ABSTRACT

A small paper dish for holding utensils while cooking. The small paper dish has a central base that has a wider end and a narrow end to accommodate the handle of a utensil. The base has a sidewall and a sidewall rim to keep the utensil secured on the dish when not in use. The dish has a neck which is designed to allow the utensil handle to rest on. The neck of the invention has a surface to rest the utensil on.

### FIELD OF THE INVENTION

The present invention relates to plates. More specifically, the present invention is a disposable plate designed to accommodate placement of cooking utensils.

### BACKGROUND OF THE INVENTION

When it comes to preparing and cooking a meal or a dish, there are many utensils that are used during the process of handling food. It is important to follow a set of directions when preparing and cooking a dish. During the process of preparing and cooking, many different utensils may be used to assist with handling, mixing, and preparing a dish. Some utensils are utilized multiple occasions from time to time during the process of preparing and cooking a dish. For example, when it comes a soup, a ladle or a wooden spoon is used to mix and stir the soup. After stirring and mixing the soup, the utensil will inevitably have soup residue on the surface of the utensil. The user may not want to continuously swap utensil and continuously clean the utensil. The simple solution is to have a bowl or plate to hold the utensil. Though that may be troublesome as the user will now need to clean two items instead of cleaning only the utensil that was used to mix and stir the soup.

An objective of the present invention is to provide a plate to hold cooking utensils or of the likes. The present invention provides a disposable plate that is made from paper. The present invention provides a plate to hold utensils before, during, and after the preparing and cooking process of a meal or a dish.

### BRIEF DESCRIPTION OF THE DRAWINGS

FIG. 1 is an isometric view of the present invention.

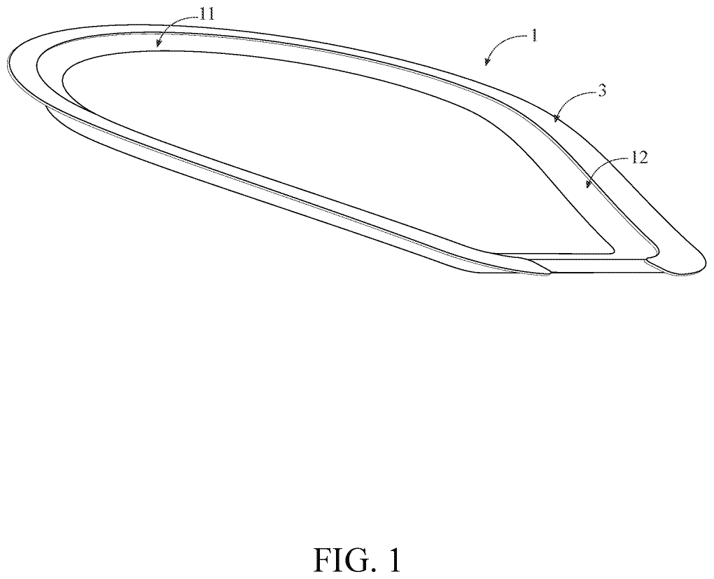

FIG. 2 is a front view of the present invention.

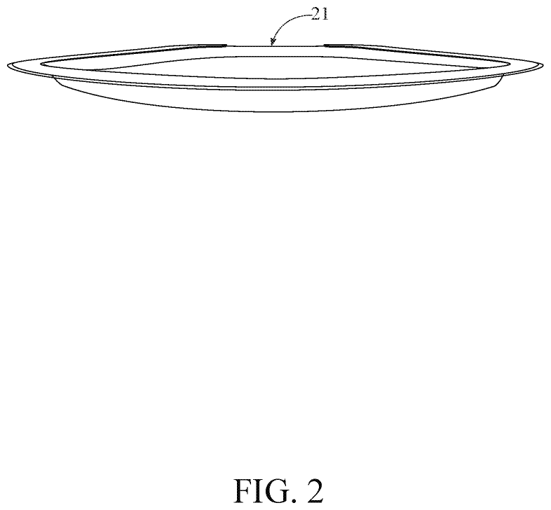

FIG. 3 is a rear view of the present invention.

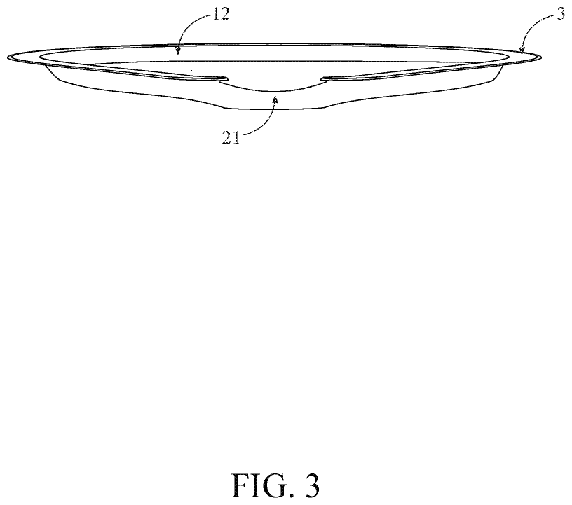

FIG. 4 is a top view of the present invention.

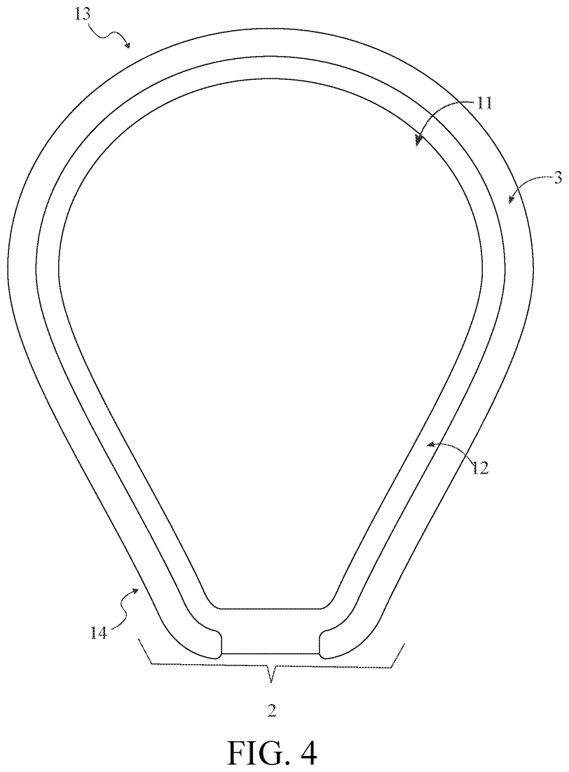

FIG. 5 is a side view of the present invention.

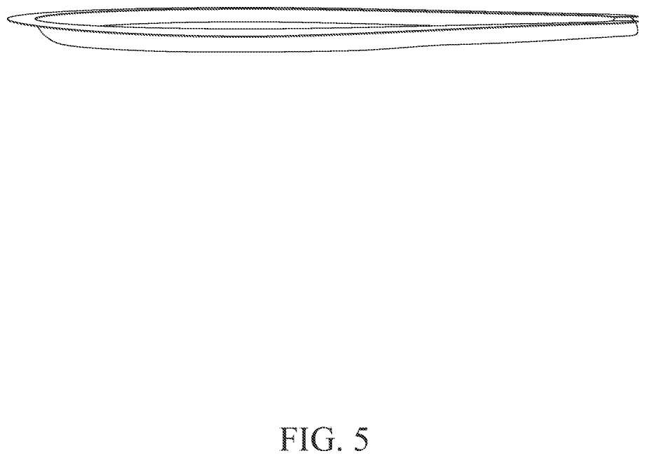

FIG. 6 is a bottom view of the present invention.

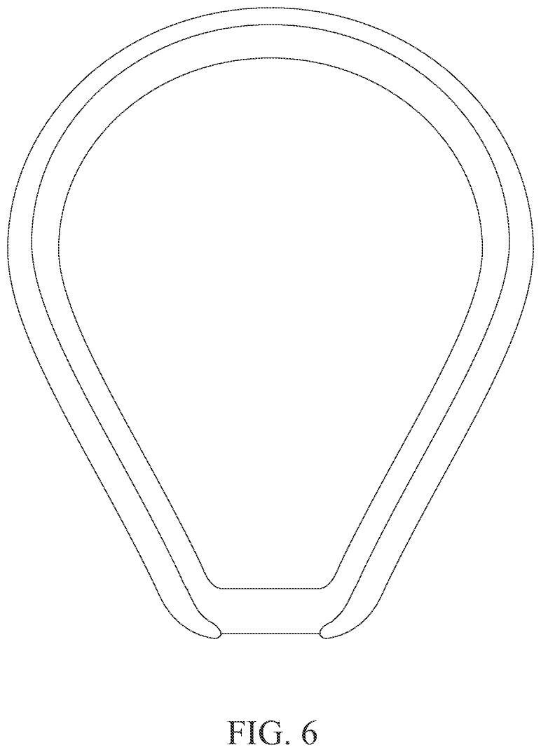

FIG. 7 is an illustration of the present invention.

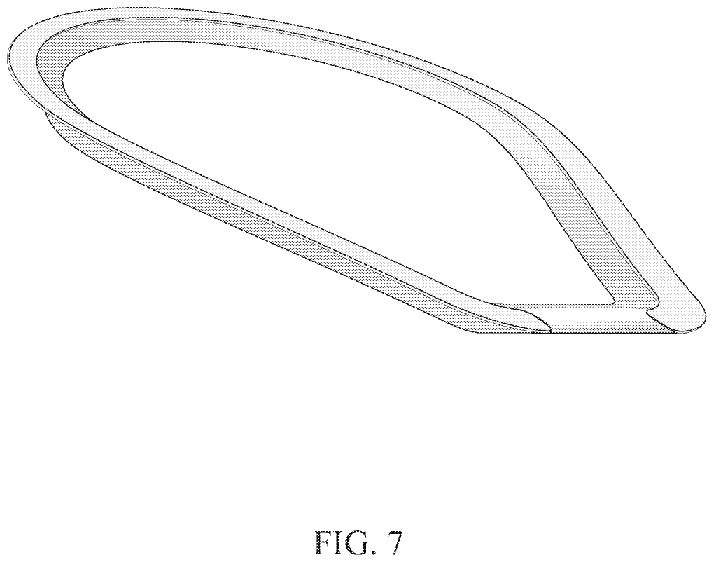

FIG. 8 is an illustration of the present invention.

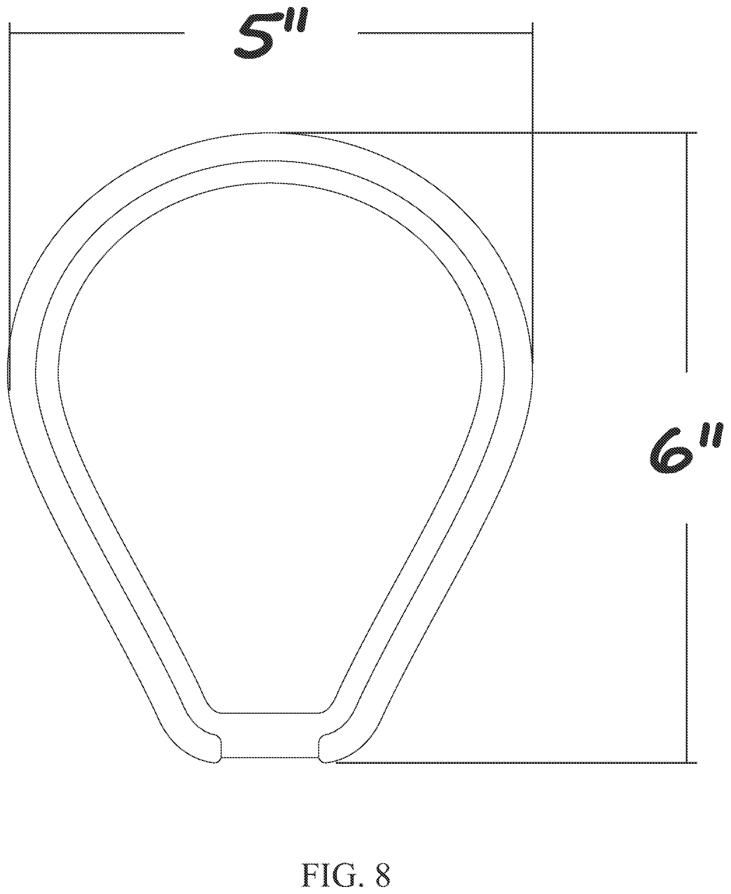

### DETAIL DESCRIPTIONS OF THE INVENTION

All illustrations of the drawings are for the purpose of describing selected versions of the present invention and are not intended to limit the scope of the present invention.

The present invention provides a plate to hold cooking utensils or of the likes. The present invention provides a disposable plate that is made from paper, cardboard, or of the likes. The present invention provides a plate to hold utensils before, during, and after the preparing and cooking process of a meal or a dish. Note that the present invention is made out of disposable material such as cardboard, paper, or of the likes. The present invention comprises a body 1 and a neck 2.

The body 1 is the primary structure of the present invention. The body 1 can be described as an oval-shaped plate. The center interior of the body 1 is flat. The body further comprises a base 11. The body 1 has a tear drop shape with the sidewall 12 curving upwards and outwards. The sidewall 12 is perimetrically positioned around the base 11. The body 1 is responsible for holding and securing the utility end of a utensil such as a wooden spoon, ladle, etc. The body 1 is coated with wax to prevent adhesion against utensils with food residue or of the likes. The wax coating of the body 1 is food-safe quality. The food-safe quality simply mean that the wax coating will not create or cause any harm for any consumables that come into contact. In addition, the body 1 is heat resistant and moisture resistant for extended utility purposes. The resistances allow for the user to place a kitchen utensil onto the body 1 without worry of damaging or harmful consequences in any shape or form. The sidewall 12 has a sidewall rim 3 which is perimetrically positioned around the sidewall 12 opposite the end of the base 11.

The body 1 has a wider end 13 and a narrow end 14 which tapers. The neck 2 is the positioned at the narrow end the body. The neck 2 is used to assist the hold and secure any extending portion of a utensil that is placed on the body 1. The neck 2 is coated with wax to prevent adhesion against utensils with food residue or of the likes. The neck 2 has a resting surface 21 in which to rest the utensils on. The wax coating of the body 1 is food-safe quality. The food-safe quality simply mean that the wax coating will not create or cause any harm for any consumables that come into contact. In addition, the neck 2 is heat resistant and moisture resistant for extended utility purposes. The resistances allow for the user to place a kitchen utensil onto the body 1 without worry of damaging or harmful consequences in any shape or form.

To use the present invention, the user will place the present invention nearby the cooking area. The user will place the present invention conveniently besides a container of food that is being prepared or cooked. When the user uses a utensil such as a ladle or a wooden spoon to mix or handle food, the user is able to place the utensil with food residue onto the present invention. The present invention will hold and secure the utensil conveniently besides the user's food to allow the user to continuously and repeatedly handle the food without the need to clean placement area of the utensil. The present invention allows for the user continuously and repeatedly place the utensil down and use the utensil conveniently. When finished, the user may throw away the present invention as it is disposable. The user will not need to clean an additional object such as a plate or a bowl as the present invention is disposable.

Although the invention has been explained in relation to its preferred embodiment, it is to be understood that many other possible modifications and variations can be made without departing from the spirit and scope of the invention.

What is claimed is:

1. A small paper dish comprising:
a body;
a neck;
a sidewall rim;
the body further comprising a base; and
the body further comprising a sidewall.

2. The small paper dish as in claim 1 further comprising:
the body having a wide end and a narrow end;
the sidewall being perimetrically positioned around the base; and
the sidewall extending outwards and upwards from the base.

3. The small paper dish as in claim 1 further comprising:
the sidewall rim being perimetrically positioned around the sidewall opposite the base.

4. The small paper dish as in claim 1 further comprising:
the neck being positioned at the narrow end of the body; and
the body and the neck being coated with wax.

5. The small paper dish as in claim 1 further comprising:
the neck having a resting surface.

6. A small paper dish comprising:
a body;
a neck;
a sidewall rim;
the body further comprising a base;
the body further comprising a sidewall;
the body having a wide end and a narrow end;
the sidewall being perimetrically positioned around the base; and
the sidewall extending outwards and upwards from the base.

7. The small paper dish as in claim 6 further comprising:
the sidewall rim being perimetrically positioned around the sidewall opposite the base.

8. The small paper dish as in claim 6 further comprising:
the neck being positioned at the narrow end of the body; and
the body and the neck being coated with wax; and
the neck having a resting surface.

9. A small paper dish comprising:
a body;
a neck;
a sidewall rim;
the body further comprising a base;
the body further comprising a sidewall;
the body having a wide end and a narrow end;
the sidewall being perimetrically positioned around the base;
the sidewall extending outwards and upwards from the base; and
the sidewall rim being perimetrically positioned around the sidewall opposite the base; and
the neck being positioned at the narrow end of the body.

10. The small paper dish as in claim 9 further comprising:
the body and the neck being coated with wax; and
the neck having a resting surface.
